(19) United States
(12) Patent Application Publication
(10) Pub. No.: US 2007/0037035 A1
(43) Pub. Date: Feb. 15, 2007

(54) Holding structure and electronic apparatus installing that therein

(76) Inventors: Miyuki Fukushi, Hitachinaka (JP); Ryuji Kohno, Kasumigaura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/354,117

(22) Filed: Feb. 15, 2006

(30) Foreign Application Priority Data
Aug. 10, 2005 (JP) 2005-231664

(51) Int. Cl. H01M 8/02; A47G 29/00

(52) U.S. Cl. 429/34; 248/689

(57) ABSTRACT

For providing a holding structure for holding a member to be held, such as a MEA, etc., suitably, while keeping holding plates to be closely contact therewith, being applicable into an electronic apparatus, a DMFC unit U1 comprises a MEA module of being an oblong on a plane view thereof, a pair of holding plates 31 for holding it between them, and bolts 41 holding the pair of holding plates at holding positions, in an outside than the MEA module on a plane view thereof, wherein each of the holding plates 31 has slits 31b and 31b, in portions corresponding to an inner area 41A inside than the holding position on the plane view thereof, in parallel with two (2) short sides 11C₁ and 11C₁ of the MEA module, facing to each other, and longer than this, for reducing transmission of stresses between portions corresponding to the short sides 11C₁ and 11C₁.

### BACKGROUND OF THE INVENTION

The present invention relates to a holding structure and an electronic apparatus installing that therein.

In recent years, developments are made vigorously upon fuel cells, such as, a Direct Methanol Fuel Cell (DMFC), etc., as an electric power supply for a portable terminal or the like. The fuel cell has a Membrane Electrode Assembly (MEA), being constructed with an anode (or a fuel electrode) and a cathode (or an air electrode), as well as, an electrolyte film or membrane being put between them. For the purpose of taking out electric energy from it, effectively, the MEA is held between a pair of conductive members (i.e., a current collector and a metal separator, etc.). And, for maintaining the condition of putting it between them in such manner, joint plates (or holding plates) are disposed on both of outsides of the conductive members, respectively, thereby connecting between the joint plates by means of a connecting bolt (see Patent Document 1).

Patent Document 1: Japanese Patent Laying-Open No. Hei 9-92323 (1997) (in particular, columns 0014-0017, FIG. 4)

However, when connection is made between the joint plates, each of the joint plates is bent to be convex-like, on fulcra or supporting points at the four (4) corners of the MEA, and therefore, sometimes, there are cases where the MEA module, being constructed with the current collector plates (i.e., the conductive members) putting the MEA therebetween, is not suitably put between them. As a result thereof, a central portion of the current collector plates are not closely contact with the MEA, preferably, and it is difficult to take out the electric energy from the MEA.

### BRIEF SUMMARY OF THE INVENTION

Then, according to the present invention, an object thereof is to provided a holding structure for holding a member to be held, such as, the MEA module or the like, as well as, the holing plates, putting them therebetween, suitably, while maintaining the holding plates to be in closely contact thereon, and also an electronic apparatus having it therein.

As a means for accomplishing the object mentioned above, according to the present invention, there is provided a holding structure, comprising: a member to be held, being a rectangle or an oblong on a plane view thereof; a pair of holding plates for holding said member to be held, putting it between them; and a holding means for holding said pair of holding plates at a holding position, in an outside than said member to be held on a plane view thereof, wherein at least one of said holding plates has at least one stress transmission reducing portion, in a portion corresponding to an inner area inside than said holding position on the plane view thereof, being in parallel with two (2) sides of said member to be held, facing to each other, and being longer than said two (2) sides, for reducing transmission of stresses between portions corresponding to said facing two (2) sides.

With such the holding structure, when the holding plates themselves are held by means of the holding means therebetween, then the holding plates in pair hold the member to be held between them. Herein, with provision of the stress transmission reducing portion on at least one of the holding plates, the stresses (compressive stress at the side of the member to be held, and tensile stress at the opposite side of the member to be held) are hardly transmitted, between portions corresponding to the facing two (2) sides of said member to be held, in said at least one thereof. With this, mainly the stresses are generated between the above-mentioned “facing two (2) sides” and “other facing two (2) sides”, within the holding plates. Then, the holding plates are bent, not on the fulcra or supporting points of the diagonals of the member to be held, but on the fulcra or supporting point of said “other facing two (2) sides” thereof. Herein, since the distance between the “other facing two (2) sides” is shorter than that between the opposite corners or diagonals, in other words, the distance comes to be short between the fulcra or supporting points, therefore for the portion of the holding plates corresponding to the center of the member to be held, it is difficult to rises upwards from the member to be held. Thus, the portion of the holding plates corresponding to the center of the member to be held comes to be in closely contact with the member to be held, easily, and as a result thereof, it is possible to hold the member to be held by putting it therebetween, suitably, by means of the holding plate as a whole.

According to the present invention, it is possible to provide the holding structure enabling to hold the member to be held therebetween, such as, the MEA module, etc., suitably, while keeping the holding plates to be closely contact therewith, and also the electronic apparatus being equipped with it.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a perspective view of a DMFC unit, according to an embodiment of the present invention;

FIG. 2 is a plane view of the DMFC unit, according to the present embodiment;

FIG. 3 is the X-X cross-section view of the DMFC unit shown in FIG. 1;

FIG. 4 is an exploded perspective view of the DMFC unit, according to the present embodiment;

FIG. 5 is a perspective view for showing stresses generated within an upper holding plate in case when no slit is provided therein, diagrammatically; and

FIG. 6 is a perspective view of a notebook type personal computer, installing the DMFC unit therein, according to the present embodiment.

### DETAILED DESCRIPTION OF THE INVENTION

Hereinafter, an embodiment according to the present invention will be fully explained by referring to the attached drawings, appropriately. Herein, according to the present embodiment, there is shown an example, wherein the member to be held in the pending claims is a MEA module, which is held by the current collector plates therebetween, while the holding structure is a DMFC unit (i.e., a fuel cell unit).

<<Structures of DMFC Unit>>

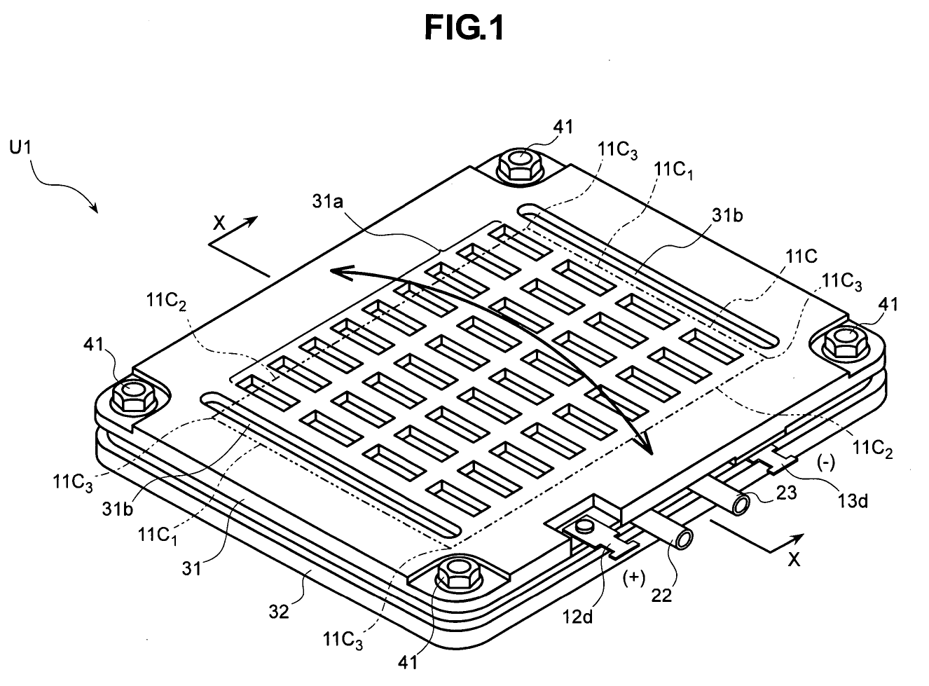

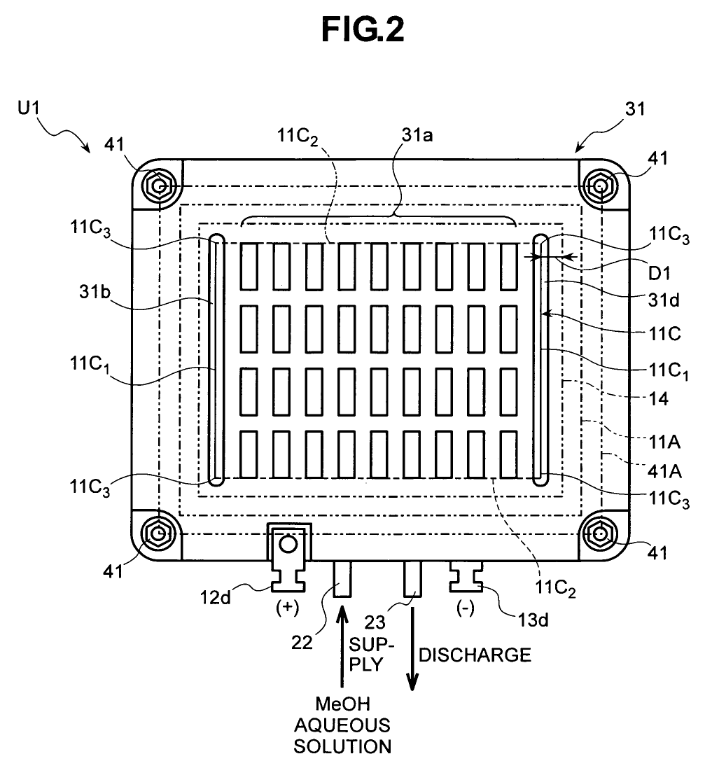

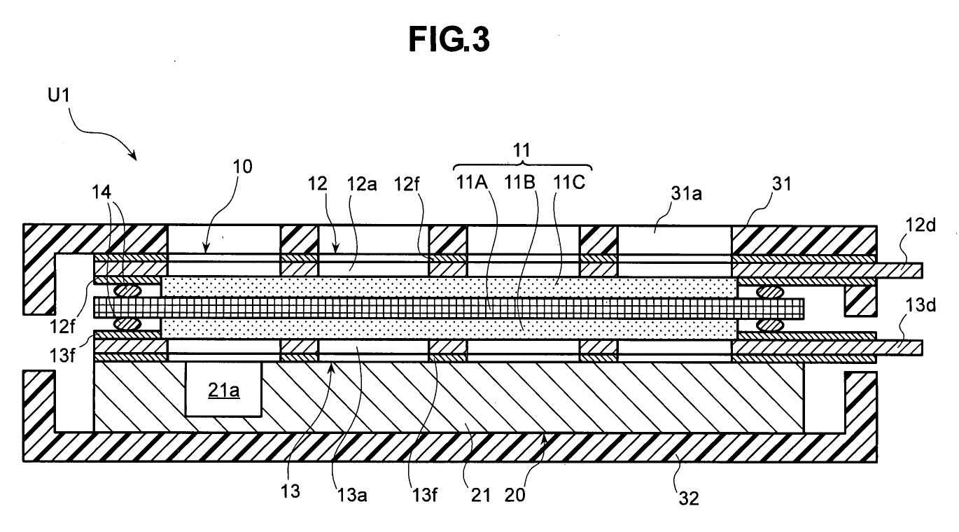

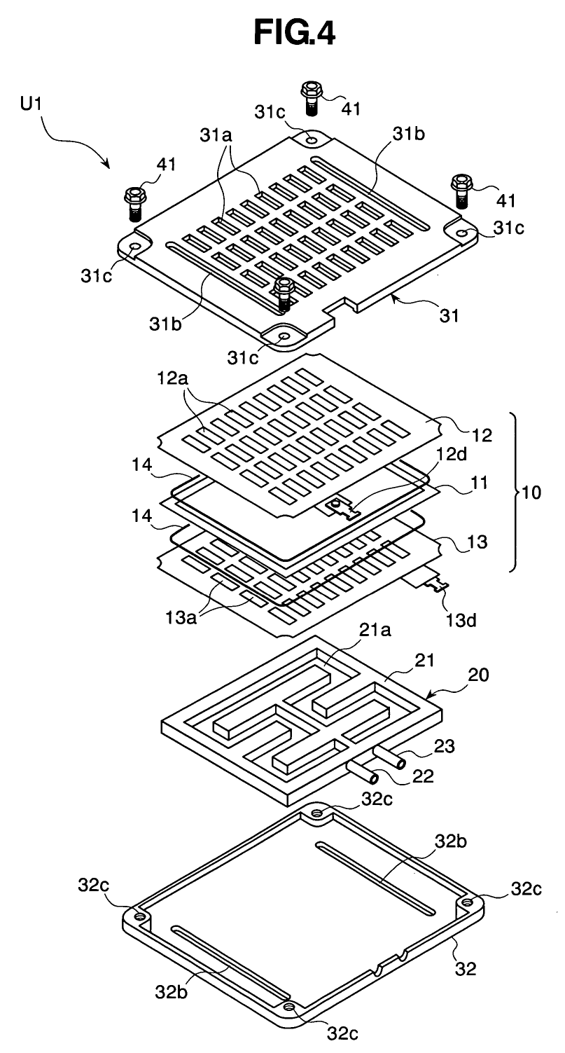

As is shown in FIG. 1, a DMFC unit U1 according to the present embodiment is an external electric power source for a portable terminal device (or an electronic apparatus), such as, a notebook-type personal computer, etc. Also, the DMFC unit U1 is a fuel cell of a passive type, utilizing natural diffusion of methanol aqueous solution and/or air, etc., but without using a pump, a fan, a blower, etc., therein. Such the DMFC unit U1 is plate-like in the shape thereof, and is oblong (or, rectangular) on a plane view thereof, approximately (see FIG. 2). The DMFC unit U1 comprises, as is shown in FIGS. 3 and 4, a MEA module 10, a fuel tank 20, an upper holding plate 31 and a lower holding plate 32 in a pair, and four (4) pieces of bolts (i.e., holding means), mainly.

<MEA Module>

The MEA module 10 comprises a MEA 11, a current collector plate 12 (i.e., a cathode current collector plate) and a current collector plate 13 (i.e., an anode current collector plate) in a pair, putting the MEA 11 therebetween, and two (2) pieces of sealing members 14 and 14. With such the MEA module 10, according to the present embodiment, is also oblong (or rectangular) on the plane view thereof.

[MEA Module]

The MEA 11 comprises an electrolyte film or membrane 11A, an anode 11B (or a fuel electrode), and a cathode 11C (or an air electrode), wherein the electrolyte membrane 11A is put between the anode 11B and the cathode 11C. And, the MEA 11 is constructed, so that it generates electricity through supplying the methanol solution (i.e., a liquid fuel) to the anode 11B while supplying the air containing oxygen therein to the cathode 11C.

Such the MEA 11 is in an oblong shape on the plane view thereof, and the electrolyte membrane 11A, the anode 11B and the cathode 11C thereof are also oblong in the shape thereof. And, the electrolyte membrane 11A is larger than the anode 11B or the cathode 11C, and outer peripheries of the anode 11B or the cathode 11C are located within an inside (a central side in direction on the plane) than the outer periphery of the electrolyte membrane 11A (see FIGS. 2 and 3).

Herein, in the present embodiment, two (2) short sides of the anode 11B or the cathode 11C facing to each other, each having the oblong shape on the plane view thereof, correspond to “two (2) pieces of short sides of the holding members, facing to each other” in the pending claims. And, for explaining about it more clearly, it is assumed that the facing short side of the cathode 11C is a short side 11C₁. However, the facing short side of the anode 11B lies at a position same to that of the short side 11C₁ of the cathode 11C, on the plane view thereof.

(Electrolyte Membrane)

The electrolyte membrane 11A is a film for transmitting proton (H⁺) generated within the anode 11B to the cathode 11C, selectively. As such the electrolyte membrane 11A, the following films may be applied, appropriately and selectively, being made from a film of perfluorocarbon sulfonic acid (PFS) group, or a copolymerized film of derivative of trifluorostyrene, a film of polybenzimidazole impregnated with phosphoric acid, a film of aromatic polyetherkethone sulfonic acid, PSSA-PVA (polystyrene sulfonic acid polyvinyl alcohol polymer), PSSA-EVOH (polystyrene sulfonic acid ethylene vinyl alcohol polymer) etc.

(Anode)

The anode 11B is an electrode, being called by a gas diffusion election, too, and it produces electrons and protons through oxidization of ethanol, being the fuel thereof. To be such the anode 11B may be applied one, carrying particles of platinum (Pt) or iron (Fe), or particles of an alloy or an oxide thereof, etc., including platinum and a transition metal, such as, nickel (Ni), cobalt (Co) or ruthenium (Ru) or the like, on a side surface of a conductive member, such as, a carbon paper, a carbon cloth, etc., facing to the electrolyte membrane 11A, as a catalyst thereof.

(Cathode)

The cathode 11C is an electrode, also being called by a gas diffusion election, too, and it makes reaction between the electrons transmitting from the anode 11B through an outer circuit and the protons reaching to the cathode 11C through moving within the electrolyte membrane 11A after being produced in the anode 11B, thereby producing water. To be such the anode 11C also may be applied that, carrying a catalyst of platinum or the like, on a side surface of a carbon paper, facing to the electrolyte membrane 11A, in the similar manner to the anode 11B.

[Current Collector Plate]

The current collector plates 12 and 13 are those for taking out electric energy therefrom, effectively, upon the basis of potential difference generated within the MEA 11, and they are made of a material having conductivity and corrosion resistance (for example, a metal, such as, titanium). Also, each of the current collector plates 12 and 13 has a predetermined thickness (for example, 0.05-0.2 mm), and has flexibility. With this, the current collector plate 12 adheres closely onto the cathode 11C and the current collector plate 13 onto the anode 11B.

The current collector plate 12 is put on an outside of the anode (i.e., an upper side in FIG. 3). And, in the current collector plate 12 are formed airflow openings 12a in plural number thereof, so that the air containing oxygen therein is supplied to the cathode 11C, passing through airflow openings 31a, which will be mentioned later, and the airflow openings 12a. Also, on the current collector plate 12 is attached a plus terminal 12d. Further, in a portion of the current collector plate 12 where it does not contact with the cathode 11C of the MEA 11, there is formed an insulating coating film 12f of a resin having an insulating property, thereby protecting it from unnecessary short-circuiting thereof.

The current collector plate 13 is put on an outside of the cathode (i.e., a lower side in FIG. 3). And, in the current collector plate 13 are formed fuel flow openings 13a in plural number thereof, so that the methanol solution is supplied to the cathode 11C, passing through the fuel flow openings 13a. Also, on the current collector plate 13 is attached a minus terminal 13d. Further, in a portion of the current collector plate 13 where it does not contact with the anode 11B of the MEA 11, there is formed an insulating coating film 13f of a resin, having an insulating property thereof.

[Sealing Member]

The sealing members 14 and 14 (i.e., O-rings) surrounds the anode 11B or the cathode 11C corresponding thereto, between an outer periphery of the anode 11B or the cathode 11C and an outer periphery of the electrolyte membrane 11A, on the plane view thereof. And, the sealing members 14 and 14 are put between the electrolyte membrane 11A and the current collector plate 12 or 13.

Further, as is shown in FIG. 2, on the plane view thereof, a predetermined gap “D1” is defined between each the sealing member 14 and the short side 11C₁ of the cathode 11C.

<Fuel Tank>

The fuel tank 20 is a secondary tank for storing the methanol solution therein, temporally, which is supplied from an outer fuel cartridge (not shown in the figure) for storing the methanol solution therein to the anode 11B of the MEA 11. The fuel tank 20 comprises a main body 21 of fuel tank (i.e., a methanol solution transmitting member), a fuel intake pipe 22, and a fuel discharge pipe 23, mainly.

On the fuel-tank main body 21 is formed a groove-like fuel flow passage 21a in a zigzag manner (see FIG. 4), so that the methanol solution can be supplied all over the surface of the anode 11B of the MEA 11, entirely.

The fuel intake pipe 22 is fixed onto the fuel-tank main body 21 in such a manner, that it is connected to the one end of the fuel flow passage 21a. The fuel discharge pipe 23 is also fixed onto the fuel-tank main body 21 in such a manner, that it is connected to the other end of the fuel flow passage 21a.

And, when the methanol solution is supplied from the fuel cartridge (not shown in the figure) into the fuel intake pipe 22, the methanol solution flows into the fuel flow passage 21a, passing therethrough. Next, the flowing methanol solution is supplied to the anode 11B, passing through the fuel flow openings 13a of the current collector plate 13. Also, the methanol solution, which does not participate in the generation of electricity, and/or carbon dioxide, which is generated in the anode 11B due to the generation of electricity, are discharged from the fuel discharge pipe 23.

Other than those, a carbon dioxide discharge tube for selectively transmitting carbon dioxide therethrough may be provided on the fuel flow passage 21a, so that the carbon dioxide can be discharged into an outside after it flows within an inside thereof. However, as such the carbon dioxide discharge tube may be used a tube-like member, being made from a porous film of a material, such as, polytetrafluorethylene, for example.

<Holding Plate>

The upper holding plate 31 and the lower holding plate 32 hold the MEA module 10 and the fuel tank 20 between them, on both outsides thereof, for maintaining the condition of laying one on top of the other. Also, the upper holding plate 31 and the lower holding plate 32 have the function of closely adhering (1) the current collector plate 12 and the cathode 11C, (2) the cathode 11C and the electrolyte membrane 11A, (3) the electrolyte membrane 11A and the anode 11B, and (4) the anode 11B and the current collector plate 13, respectively, by putting the MEA module 10 and the fuel tank 20 between them, in this manner.

[Upper Holding Plate]

The upper holding plate 31 has a plural numbers of airflow openings 31a, corresponding to the plural numbers of airflow openings 12a, which are formed on the current collector plate 12 on the side of the cathode 11C. Also, the upper holding plate 31 has slits 31b and 31b (a stress transmission reducing portion). As is shown in FIG. 2, the slits 31b and 31b are positioned on the short sides 11C₁ and 11C₁ of the cathode 11C, within an inside from the sealing member 14, on the plane view thereof. Thus, each of the slits 31b is in parallel with the short side 11C₁. Also, the length of the each slit 31b is determined to be shorter than that of the short side 11C₁.

[Lower Holding Plate]

The lower holding plate 32 has also slits 32a and 32a (the stress transmission reducing portion), in the similar manner to the upper holding plate 31. The slits 32b and 32b are positioned on the short sides of the anode 11B, within an inside from the sealing member 14, on the plane view thereof. And, each of the slit 32b is in parallel with the short side of the anode 11B, and is longer than the short side mentioned above.

<Bolt>

Four (4) pieces of bolts 41, being holding means for holding the upper holding plate 31 and the lower holding plate 32 therebetween, are inserted into bolt insertion openings 31c of the upper holding plate 31, and are screwed into screw openings 32c of the lower holding plate 32. Also, as is shown in FIG. 2, on the plane view thereof, the holding positions of the four (4) pieces of bolts 41 are located outside the electrolyte membrane 11A building up the MEA module 10, on the plane thereof. The electrolyte membrane 11A, the anode 11B, the cathode 11C, the sealing members 14 and 14, and the slits 31b and 32b are positioned within an inner area inside the holding positions of the bolts 41.

<<Stress within Holding Plate>>

Explanation will be given about the stresses, which are generated on the upper holding plate 31 and the lower holding plate 32, under the condition of assembling such DMFC unit U1.

First of all, explanation will be given on the stress, which is generated on the upper holding plate 31.

Under the condition of being held by the four (4) pieces of bolts 41, the stress is hardly generated (tensile stress on an upper side, and compressive stress on a lower side) between the slits 31b and 31b, i.e., the portion corresponding to the inner area 41A of the upper holding plate 31. In other words, it is reduced down to reach to zero (0). On the other hand, since no slit is formed in a portion of the upper holding plate 31, corresponding to the two (2) pieces of long sides 11C₂ and 11C₂ of the cathode 11C (i.e., two (2) sides other than the two (2) pieces of short sides), stresses are generated between the portions of the upper holding plate 31 corresponding to the long sides 11C₂ and 11C₂. As a result thereof, the upper holding plate 31 is bent to be convex upwards, upon the fulcra or supporting points of the long sides 11C₂ and 11C₂ of the cathode 11C (see FIG. 1).

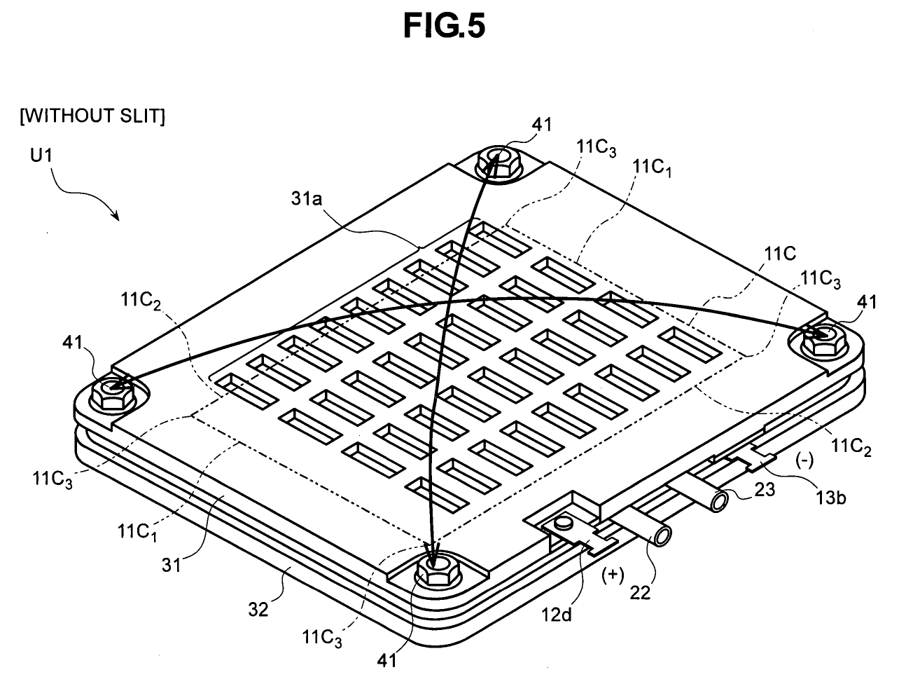

On the contrary to this, when such slits 31b and 31b are not formed in the upper holding plate 31, the stress is also generated between the portions corresponding to the short sides 11C₁ and 11C₁ of the cathode 11C, and as a result of combining this one with the stress between the portions of the long sides 11C₂ and 11C₂, the upper holding plate 31 is bent in a cone-like manner, approximately, mostly projecting upwards at the central portion thereof, upon the fulcra or supporting points of the opposite corners or diagonals 11C₃ and 11C₃ of the cathode 11C (see FIG. 5).

Thus, the distance between the long sides 11C₂ and 11C₂, operating as the fulcra or supporting points when the slits 31b and 31b are formed, is shorter than the distance between the diagonals 11C₃ and 11C₃, operating as the fulcra or supporting points when the slits 31b and 31b are not formed. With this, in a case when the distances connecting between the upper holding plate 31 and the lower holding plate 32 by means of the bolts are equal to each other, the central portion of the upper holding plate 31 hardly comes up from the current collector plate 12. In other words, the upper holding plate 31 suppresses the current collector plate 12 towards the MEA 11, even at the central portion thereof. As a result thereof, (1) the current collector plate 12 and the cathode 11C, and (2) the cathode 11C and the electrolyte membrane 11A closely adhere, respectively, in a preferable manner.

Also, due to the fact that each of the slits 31b is located on each the short side 11C₂, inside the sealing member 14, the stress is transmitted to the upper holding plate 31 on the sealing member 14. With this, the sealing member 14 is held between the electrolyte membrane 11A and the current collector plate 12, desirably, and thereby maintaining preferable sealing property thereof.

At the same time, since it is also formed with the slits 32b and 32b therein, them the lower holding plate 32 hardly rises up the central portion thereof from the fuel tank 20. Namely, the lower holding plate 32 suppresses the fuel tank 20 towards the MEA 11 at the central portion thereof. As a result thereof, (3) the electrolyte membrane 11A and the cathode 11B, and (4) the anode 11B and the current collector plate 12 closely adhere, respectively, in a preferable manner.

<<Operation of DMFC Unit>>

Next, the operations of the DMFC unit U1 will be explained, by mainly referring to FIG. 3.

<DMFC Unit—Anode Side>

First, explanation will be given about the DMFC unit U1, in particular, on the side of the anode 11B thereof.

The methanol solution (for example, including methanol of 10 weight % in concentration thereof) is supplied into the fuel flow passage 21a of the fuel tank 20, from a fuel cartridge in an outside through the fuel intake pipe 22. The methanol solution supplied into the fuel flow passage 21a, then it is supplied to the anode 11B all over the surfaces thereof, through the fuel flow openings 13a.

On the anode 11B, to which the methanol solution is supplied, the methanol solution reacts on water, thereby producing proton (H⁺), carbon dioxide (CO₂) and electron (e⁻), under the existence of the catalyst, such as, platinum or the like being carried, as is shown by the following equation (1), depending on a demand of electric power from a portable terminal device, to which the DMFC unit U1 is connected. Next, the proton (H⁺) moves towards the cathode 11C within the electrolyte film or membrane 11A, with driving force due to the concentration gradient thereof.
CH₃OH+H₂O→CO₂+6H⁺+6e⁻ (1)

On the other hand, the carbon dioxide produced in the anode 11B, as is shown by the equation (1), is discharged into an outside from the fuel discharge pipe 23, together with the methanol solution, not taking a part in the generation of electricity, after moving into the fuel flow passage 21a from the anode 11B passing through the fuel flow openings 13a.

<DMFC Unit—Cathode Side>

Next, explanation will be given about the DMFC unit U1, in particular, on a side of the cathode 11C.

Air containing oxygen therein is supplied to the cathode 11C of the MEA 11, passing through the plural number of airflow openings 13b of the current collector plate 13. On the cathode 11C, the oxygen reacts on the proton (H⁺) moving within the electrolyte membrane 11A and the electron (e⁻) via the outside electronic apparatus, thereby producing water, as is shown by the following equation (2).
O₂+4H⁺+4e⁻→2H₂O (2)

Due to continuous generation of such reactions upon the anode 11B and the cathode 11C, the DMFC unit U1 makes the generation of electricity, continuously.

Herein, as was mentioned above, within the DMFC unit U1 according to the first embodiment, (1) the current collector plate 12 and the cathode 11C, (2) the cathode 11C and the electrolyte membrane 11A, (3) the electrolyte membrane 11A and the anode 11B, and (4) the anode 11B and the current collector plate 13 adhere to each other, respectively, in the preferable manner, and therefore it is possible to take out electric energy, effectively, upon basis of the potential difference generated within the MEA 11.

Although the explanation was made in the above, about one example of the preferred embodiment according to the present invention, however the present invention should not be restricted onto to such the embodiment as was mentioned above, and therefore the following changes may be made, for example, within a breadth not departing from the gist of the present invention.

The explanation was made on the case where the slits 31b and 32b are formed on the upper holding plate 31 and the lower holding plate 32, respectively, in the embodiment mentioned above, but the slit may be formed only on either one thereof, in the structures thereof.

Though the upper holding plate 31 has two (2) pieces of the slits 31b and 31b, in the embodiment mentioned above, the number of the slits 31b should not be limited to this, but it may be one (1) piece or three (3) pieces or more than that.

Although the explanation was made on the case where the stress transmission reducing portion in the pending claims is achieved by the slits 31b and 32b, in the embodiment mentioned above, however that stress transmission reducing portion may be other than that, for example, a low rigidity portion made of a material, being lower than the other portions in the stiffness or rigidity thereof, or may be a groove (or notch), etc.

Although the explanation was made on the case where the MEA module 10, as being the member to be held, is oblong on the plane view thereof, in the embodiment mentioned above, however it should not be limited thereto, and the plane view of the member to be held may be a square.

Although the explanation was made on the case where the member to be held is the MEA module 10, in the embodiment mentioned above, however it should not be limited thereto, and the member to be held may be any one other than that. Also, though the explanation was made on the case where the holding structure is the DMFC unit U1, as an example, but it should not be limited to this, but it may be any one other than that.

Although the explanation was made on the case where the slits 31b and 31b are located on the short sides 11C₁ and 11C₁ on the plane view thereof, in the embodiment mentioned above, however they should not restricted to the above, they may be located above at the distance D1 between the sealing member 14 and the short side 11C₁ of the cathode 11C, or may be one crossing over the cathode 11C.

Although the explanation was made on the case where the MEA module 10 is disposed only on one side (i.e., the upper side) of the fuel tank 20, in the embodiment mentioned above, however other than that, it may be a case where the MEA modules 10 and 10 may be disposed on both sides of the fuel tank 20, so as to share the fuel tank 20 by the anode 11B of each of the MEA modules.

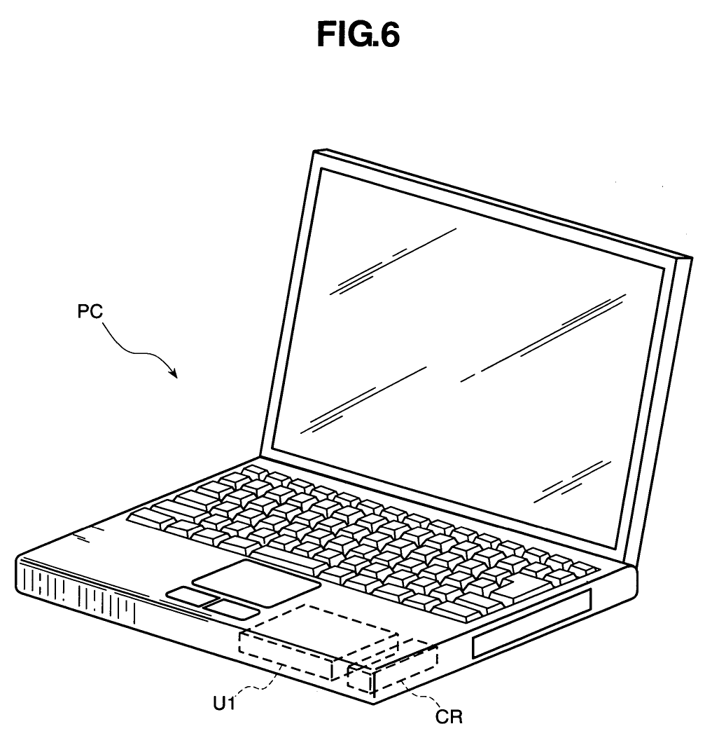

Although the explanation was made on the case where the DMFC unit U1 is used as an outer electric power source for the terminal device, in the embodiment mentioned above, however as is shown in FIG. 6, the DMFC unit U1 may be installed into an notebook type personal computer (i.e., an electronic apparatus) together with the fuel cartridge CR, in the structures thereof, so that the notebook type personal computer operates on the electricity from the DMFC unit U1 (i.e., the MEA 11) in the structures thereof.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A holding structure, comprising:
a member to be held, being a rectangle or an oblong on a plane view thereof;
a pair of holding plates for holding said member to be held, putting it between them; and
a holding means for holding said pair of holding plates at a holding position, in an outside than said member to be held on a plane view thereof, wherein
at least one of said holding plates has at least one stress transmission reducing portion, in a portion corresponding to an inner area inside than said holding position on the plane view thereof, being in parallel with two (2) sides of said member to be held, facing to each other, and being longer than said two (2) sides, for reducing transmission of stresses between portions corresponding to said facing two (2) sides.

2. The holding structure, as described in the claim 1, wherein said stress transmission reducing portion includes a slit.

3. The holding structure, as described in the claim 1, wherein said stress transmission reducing portion is a low rigidity portion being lower than other portions in rigidity thereof.

4. The holding structure, as described in the claim 1, wherein said member to be held is the oblong on the plane view thereof, and said two (2) facing sides thereof are facing short sides of said oblong.

5. The holding structure, as described in the claim 1, wherein said member to be held comprises an electrolyte membrane assembly, being constructed by putting an electrolyte membrane between a pair of electrodes, so as to generate electricity through supply of a liquid fuel thereto, and a pair of current collector plates putting said electrolyte membrane assembly therebetween, and said facing two (2) sides are two (2) sides of said electrodes.

6. The holding structure, as described in the claim 5, wherein said electrolyte membrane is larger than said electrode on a plane view thereof, and an outer periphery of said electrode is positioned in an inside than an outer periphery of said electrolyte membrane, and further comprises sealing members, each surrounding each of said electrodes and also being put between said electrolyte membrane and said current collector plate corresponding thereto, between the outer periphery of said electrode and the outer periphery of said electrolyte membrane, on the plane view thereof, and
said stress transmission reducing portion is positioned inside than said sealing member on the plane view thereof.

7. The holding structure, as described in the claim 6, wherein a gap is defined between said seal member and said outer peripheries of said facing two (2) sides of said electrode, which is surround by said seal member, and
said stress transmission reducing portion is positioned on the two (2) facing sides of said electrodes or between said two (2) sides and said seal member.

8. An electronic apparatus, comprising the holding structure as described in the claim 5 therein, wherein said electronic apparatus operates upon electricity generated from said an electrolyte membrane assembly.
